(19) United States
(12) Patent Application Publication
(10) Pub. No.: US 2018/0305600 A1
(43) Pub. Date: Oct. 25, 2018

(54) EXOTHERMIC REACTANTS FOR USE IN SUBTERRANEAN FORMATION TREATMENT FLUIDS

(71) Applicant: Halliburton Energy Services, Inc., Houston, TX (US)

(72) Inventors: Bryan Chapman LUCAS, Duncan, OK (US); Chad A. FISHER, Cache, OK (US); Melissa Christine WESTON, Thornton, CO (US)

(21) Appl. No.: 15/767,632

(22) PCT Filed: Mar. 9, 2016
(86) PCT No.: PCT/US2016/021452

§ 371 Date: Apr. 11, 2018

(51) Int. Cl. C09K 8/06; C09K 8/68; C09K 8/86; E21B 43/24

(52) U.S. Cl. CPC C09K 8/06; E21B 43/2405; C09K 8/86; C09K 8/68

(57) ABSTRACT

Methods including providing a fluid flow path allowing the passage of a treatment fluid comprising an aqueous base fluid therethrough. Introducing an exothermic reactant into the fluid flow path to react with the aqueous base fluid and heat the treatment fluid. Introducing a gelling polymer into the fluid flow path and hydrating the gelling polymer. Introducing the treatment fluid into a subterranean formation.

### BACKGROUND

The present disclosure relates generally to subterranean formation operations and, more particularly, to heating treatment fluids using exothermic reactants to reduce gelling polymer hydration time.

During the drilling, completion, and production of a subterranean formation, such as a hydrocarbon-producing well, various wellbore treatment fluids are circulated in and/or out of the well. Such fluids may include, but are not limited to, drilling fluids, drill-in fluids, completion fluids, fracturing fluids, work-over fluids, and the like. These fluids used in various subterranean formation operations, may be collectively referred to as “treatment fluids”. Treatment fluids often include a plurality of particles that impart specific properties (e.g., rheology, mud weight, and the like), capabilities (e.g., wellbore strengthening, fluid loss control, and the like), and functionalities (e.g., forming a proppant pack, forming a gravel pack, and the like) to the treatment fluid.

Prior to being conveyed downhole, a treatment fluid may be treated by adding or removing various components to obtain a predetermined treatment fluid mixture designed for optimal efficiency of the subterranean operation being performed (e.g., drilling, fracturing, and the like). Gelling polymers, for example, are often added to treatment fluid to produce a desired viscosity. Once hydrated and at a sufficient concentration, the gelling polymers increase the viscosity of the treatment fluid to achieve a variety of purposes, such as, particle suspension (e.g., proppant or other solids suspension), fracture initiation and geometry, and the like.

The gelling polymer typically is hydrated at a surface location in a blender apparatus. The gelling polymer is added to the liquid portion of the treatment fluid and it typically takes several hours for the gelling polymer to hydrate. Once hydrated, the viscosified liquid portion of the treatment fluid may be introduced directly into a subterranean formation to perform a particular operation (e.g., a fracturing operation) or may first have additional desired additives added thereto and thereafter introduced into a subterranean formation to perform a particular operation.

### BRIEF DESCRIPTION OF THE DRAWINGS

The following figure is included to illustrate certain aspects of the examples and embodiments described herein, and should not be viewed as exclusive. The subject matter disclosed is capable of considerable modifications, alterations, combinations, and equivalents in form and function, as will occur to those skilled in the art and having the benefit of this disclosure.

FIG. 1 is a schematic illustration of hydrating a gelling polymer in a complete treatment fluid using an exothermic reactant.

FIG. 2 is a schematic illustration of hydrating a gelling polymer in a portion of a treatment fluid using an exothermic reactant.

FIG. 3 is a cross-sectional schematic illustration of a system configured for delivering treatment fluids described herein to a downhole location.

FIG. 4 is a chart illustrating the effect of temperature and pH on gelling polymer hydration.

FIG. 5 is a chart illustrating gelling polymer hydration time based on different hydration systems.

### DETAILED DESCRIPTION

The present disclosure relates generally to subterranean formation operations and, more particularly, to heating treatment fluids using exothermic reactants to reduce gelling polymer hydration time.

Current treatment fluids are formulated using hydratable gelling polymers, which are mixed with an aqueous fluid at a surface location (e.g., at a wellbore/job site). The term “hydration,” and grammatical variants thereof, is the process by which a hydratable material (e.g., a gelling polymer) solvates with an aqueous fluid (i.e., a water-based fluid) as the solvent. A gelling polymer thus solvates by absorption of an aqueous fluid and swells.

Hydration of a gelling polymer in an aqueous fluid can take several hours or more at typical surface conditions temperatures, and the like). This long hydration time can result in significant waiting time during oil and gas operations, failure to adequately hydrate the gelling polymer prior to introduction of the treatment fluid downhole, and the like. For example, continuous mix applications are often used to formulate treatment fluids and introduce those treatment fluids into a subterranean formation, and such operations typically take place over a relatively short period of time. In such instances, the long hydration time of the gelling polymers may result in insufficient hydration prior to introduction of the continuous mixed treatment fluids, thus reducing the efficiency or efficacy of the treatment fluid. In cold climates or climates having temperatures below gelling polymer hydration temperatures, gelling polymers may additionally be poorly hydrated in treatment fluids, resulting in increased gelling polymer loading to compensate for the poor hydration.

The present disclosure utilizes compositions, methods, and systems to heat all or a portion of a treatment fluid using an exothermic reactant. The exothermic reactant is introduced into a fluid flow path comprising all or a portion of a treatment fluid, where the exothermic reactant causes the treatment fluid to increase in temperature, thereby resulting in a reduction of gelling polymer hydration time and also a reduction of residual gelling agent in a subterranean formation due to hydration failure. Additionally, the examples and embodiments described herein allow a specified viscosity to be achieved in a reduced amount of time that would be the case in the absence of the exothermic reactant. One advantage of the present disclosure also includes use of the exothermic reactant to heat only a portion of the treatment fluid, thus reducing costs due associated with energy requirements for heating large volumes of treatment fluid. It will be appreciated, however, that the exothermic reactant can also be used to heat a full volume of a treatment fluid, without departing from the scope of the present disclosure.

Not all features of an actual implementation are described or shown in this application for the sake of clarity. It is understood that numerous implementation-specific decisions may need to be made to achieve the developer's goals, such as compliance with system-related, lithology-related, business-related, government-related, and other constraints, which vary by implementation and from time to time. While a developer's efforts might be complex and time-consuming, such efforts would be, nevertheless, a routine undertaking for those of ordinary skill in the art having benefit of this disclosure.

It should be noted that when “about” is provided herein at the beginning of a numerical list, the term modifies each number of the numerical list. In some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as molecular weight, reaction conditions, and so forth used in the present specification and associated claims are to be understood as being modified in all instances by the term “about.”

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about” may refer to a +1-5% numerical value. For example, if the numerical value is “about 5,” included is an upper limit of 5.25 to a lower limit of 4.75, encompassing any value and subset therebetween. Accordingly, unless indicated to the contrary, the numerical parameters set forth in the following specification and attached claims are approximations that may vary depending upon the desired properties sought to be obtained based on the present disclosure. At the very least, and not as an attempt to limit the application of the doctrine of equivalents to the scope of the claim, each numerical parameter should at least be construed in light of the number of reported significant digits and by applying ordinary rounding techniques.

It should further be noted that, as used herein, the term “substantially” means largely, but not necessarily wholly.

While compositions and methods are described herein in terms of “comprising” various components or steps, the compositions and methods can also “consist essentially of” or “consist of” the various components and steps. When “comprising” is used in a claim, it is open-ended.

The present disclosure provides a method of treating a full or partial volume of a treatment fluid in a fluid flow path for introduction into a subterranean formation with an exothermic reactant. As used herein, the term “fluid flow path,” and grammatical variants thereof, refers to a conduit or vessel that allows or creates dynamic movement of a fluid. The term “fluid,” and grammatical variants thereof, as used herein refers to both liquid phase and gas phase fluids. Accordingly, the fluid flow path may be a tubular conduit that conducts fluid from one location to another, or the fluid flow path may be a mixing tank that agitates or dynamically moves fluid therein, without departing from the scope of the present disclosure.

In one example, a fluid flow path is generated that allows passage of a treatment fluid therethrough, where the treatment fluid comprises an aqueous base fluid. The treatment fluid may further comprise, as discussed below, additional additives, without departing from the scope of the present disclosure. An exothermic reactant is then introduced into the fluid flow path and reacted with the aqueous fluid, thereby heating the treatment fluid. This can include the entire amount of treatment fluid, such that the exothermic reactant is selected in type and amount to heat the entire volume of the treatment fluid to a desired temperature. Thereafter, a gelling polymer is included in the fluid flow path, where the heated treatment fluid hydrates the gelling polymer. The hydrated treatment fluid is then introduced into a subterranean formation to perform a subterranean formation operation.

Alternatively, rather than heating the entirety of the treatment fluid, only a portion of the treatment fluid is heated with the exothermic reactant and the gelling polymer is thus hydrated in said portion prior to rejoining the hydrated treatment fluid portion with the remaining volume of the treatment fluid. In such instances, only a small amount (or relatively small amount) of the treatment fluid requires heating, thus reducing the amount of exothermic reactant. Advantageously, the amount of gelling polymer included in the portion of the treatment fluid with the exothermic reactant need not be reduced or scaled, but rather the amount of gelling polymer needed to viscosify the entirety of the treatment fluid can be hydrated in merely the portion of the treatment fluid due to the heat created by the exothermic reactant.

In those examples in which the exothermic reactant is only added to a portion of a treatment fluid, a first and second fluid flow path is generated. The first fluid flow path allows passage of a treatment fluid comprising an aqueous base fluid. The second fluid flow path allows passage of a portion of the treatment fluid. For example, and as described in more detail below, a portion of the treatment fluid can be diverted from the first fluid flow path and into the second fluid flow path, where the remainder of the treatment fluid remains in the first fluid flow path. An exothermic reactant is introduced into the second fluid flow path, where it reacts with the aqueous base fluid in the portion of the treatment fluid in the second fluid flow path, thereby heating the portion of the treatment fluid therein. A gelling polymer is introduced into the second fluid flow path only, where it is hydrated in the heated second fluid flow path due to the exothermic reactant. Thereafter, the first fluid flow path and the second fluid flow path are joined together to form a complete treatment fluid, which is introduced into a subterranean formation to perform a subterranean formation operation.

In some examples, the compositions, methods, and systems described herein may be with reference to particular subterranean formation operations (e.g., hydraulic fracturing operations). However, the compositions, methods, and systems described herein may be used in any subterranean formation operation that may benefit from their advantages described herein, including their ability to heat a treatment fluid and facilitate gelling polymer hydration. Such subterranean formation operations include, but are not limited to, a drilling operation, a stimulation operation, an acidizing operation, an acid-fracturing operation, a sand control operation, a fracturing operation, a frac-packing operation, a gravel-packing operation, a production operation, a remedial operation, a gas hydrate removal operation, an enhanced oil recovery operation, an injection operation, a pipeline operation (e.g., transporting hydrocarbon fluids through a pipeline), a remedial operation, a formation damage reduction operation, a cementing operation, and the like, and any combination thereof.

As previously described, the treatment fluids of the present disclosure comprise an aqueous base fluid. The aqueous base fluid used in forming the treatment fluids described herein may be any aqueous base fluid suitable for use in a subterranean formation and able to react with an exothermic reactant to heat the treatment fluid. Suitable aqueous base fluids include, but are not limited to, fresh water, saltwater (e.g., water containing one or more salts dissolved therein), brine (e.g., saturated salt water), seawater, or combinations thereof. Generally, the water may be from any source, provided that it does not contain components that might adversely affect the stability and/or performance of the treatment fluids of the present disclosure (e.g., the ability of the exothermic reactant to heat the treatment fluid). For example, the water may be recovered water (i.e., water used as part of a subterranean formation operation), reclaimed water (i.e., wastewater (sewage) that has been treated to remove certain impurities and/or solids), and the like.

The “exothermic reactant,” and grammatical variants thereof, for use in heating the treatment fluids described herein is any compound capable of reacting with an aqueous base fluid to cause an exothermic reaction. As used herein, the term “exothermic reaction,” and grammatical variants thereof, refers to a chemical reaction accompanied by the evolution of heat. Accordingly, the reaction releases energy that creates heat (e.g., the exothermic reactant may release light that results in heating the treatment fluid). In any example described herein, the exothermic reactant may be an anhydrous compound that reacts with an aqueous base fluid to produce heat. For example, the exothermic reactant may be anhydrous ammonia, anhydrous copper (II) sulfate, and any combination thereof.

In preferred examples, although without limitation, all or a portion of the exothermic reactant is anhydrous ammonia (AA). It has been found that despite the pH alteration that can occur due to the reaction of AA (or other exothermic reactants described herein) with an aqueous base fluid, the exothermic heat produced overcomes such pH problems typically associated with a reduced hydration time for gelling polymers, as described below. These high pH conditions may be found naturally, as well, such as in clay control operations where the clay control agents impart elevated pH to treatment fluids. The use of AA (or other exothermic reactants described herein) can overcome those pH issues that generally reduce hydration times of gelling polymers. Accordingly, the use of AA (or other exothermic reactants described herein) to elevate treatment fluid temperatures can also reduce or eliminate the need for certain pH control additives. Additionally, in some instances high pH is desirable, such as to stabilize gels used at formation temperatures. The use of AA (or other exothermic reactants described herein) can thus be used to elevate both the temperature of the treatment fluid and achieve desirably gelling polymer hydration times and the pH of the treatment fluid, thus reducing or eliminating the need for certain high pH control additives used to elevate pH.

Moreover, the use of AA as an exothermic reactant acts as a biocide that will reduce or preclude the rapid growth of bacteria, or may eliminate bacterial growth completely, and the presence of bacteria can cause a loss of fluid viscosity. Fluid viscosity reduction is caused by the bacteria releasing enzymes that degrade gelling polymers into sugars, which the bacteria use as a food source to multiply. The ability of AA (and other exothermic reactants) to increase pH (e.g., greater than about pH 10) lends them to use as biocide-acting compounds, as well as denature any enzymes produced from existing bacteria. Accordingly, the exothermic reactants described herein have a multiple synergistic purpose, of heating all or a portion of a treatment fluid to expedite gelling polymer hydration, providing bacterial growth protection within the treatment fluid, enabling further viscosity enhancement, and protecting the degradation of the fluid viscosity.

The AA may be a liquid, a foam, or a meso-solid, such as a surfactant-ammonia blend, without departing from the scope of the present disclosure. The AA may be in a liquid phase, a gaseous phase, a supercritical phase, and any combination thereof, without departing from the scope of the present disclosure, and may depend on a number of factors such as pressure, temperature, percent concentration, and the like.

The AA may be readily generated by the Haber process, which generates the AA by a reaction of nitrogen gas and hydrogen gas. In some instances, natural gas may be used as the source for the hydrogen gas and air may be used as the source for the nitrogen gas, both readily available in and regions, as well as other regions. The ease of generation of AA through the Haber process, for example, may permit such generation to occur at a well site or location geographically close thereto. Such generation may additionally be achieved at another location off site, without regard to the well site location, without departing from the scope of the present disclosure. Moreover, the generation of AA may be relatively low in cost, and may be particularly beneficial where the cost of water exceeds the cost of generating the AA or where local legislation prohibits water use (or large amounts of water use).

When the exothermic reactant selected is AA (alone or in combination with any other exothermic reactant), it may be included in either a portion or a total volume of a treatment fluid to heat the portion or total volume thereof in an amount of less than about 10% by weight of the aqueous base fluid to which it is added, but at least about 1% by weight of the aqueous base fluid, encompassing any value and subset therebetween. Accordingly, the AA may be present of from about 1% to about 10%, or about 1% to about 2%, or about 2% to about 4%, or about 4% to about 6%, or about 6% to about 8%, or about 8% to about 10%, or about 2% to about 8%, or about 3% to about 7%, or about 4% to about 6% by weight of the aqueous base fluid to which it is added, encompassing any value and subset therebetween. These ranges are additionally applicable to any other exothermic reactant for use in the embodiments of the present disclosure.

The exothermic reactant is selected to achieve a temperature greater than the first temperature of the treatment fluid when it is introduced initially into a hydration system, and a temperature at which accelerated hydration of one or more particular gelling polymers can be achieved. In a specific example, the exothermic reactant raises the temperature of the all or portion of the treatment fluid into which it is added to achieve a temperature of greater than ambient temperatures or greater than about 35° F. (an equivalent of about 2° C.), or greater than about 50° F. (an equivalent of about 10° C.), or greater than about 75° F. (equivalent to about 24° C.), or greater than about 100° F. (equivalent to about 38° C.), or greater than about 125° F. (equivalent to about 52° C.), or about 150° F. (equivalent to about 66° C.). Generally, the exothermic reactant does not raise the temperature of the all or portion of the treatment fluid into which it is added to achieve a temperature of greater than about 150° F., as temperatures much higher than 150° F. may interfere negatively with equipment components. In some cases, the exothermic reactant may achieve an elevated temperature that is greater than the first temperature by at least about 75° F. (about 24° F.).

For example, adding 10% of AA to fresh water will produce 348.3 British thermal units (BTU) per pound of AA. If this concentration of AA was added to only a portion of a treatment fluid (e.g., the hydration system of FIG. 2), the AA could be added at a rate of about 30 gallons per minute (gpm), which would raise the temperature of the portion of the treatment fluid about 35° F. This is sufficient to decrease gelling polymer hydration time and only requires a relatively small amount of AA, since the AA is added only to a portion of the treatment fluid. It is to be appreciated, however, as described herein, that the AA can also be used to heat a full (or complete) treatment fluid volume, without departing from the scope of the present disclosure. Additional data on AA treatment fluids in fresh water is provided in Table 1, indicating temperature increases for 10% AA, 20% AA, and 30% AA treatment fluid solutions based on a fluid rate of 10 barrels per minute.

TABLE 1

| AA Concentration in | | Temperature Increase |
|---|---|---|
| Fresh Water | Energy (BTU) | (° F.) |
| 10% | 115471 | 34.38 |
| 20% | 213768 | 65.7 |
| 30% | 291133 | 92.46 |

The gelling polymers for use in the treatment fluids described herein may be a naturally-occurring gelling polymer, a synthetic gelling polymer, and any combination thereof. Suitable gelling polymers include, but are not limited to, polysaccharides, biopolymers, and/or derivatives thereof that contain one or more of the monosaccharide units: galactose, mannose, glucoside, glucose, xylose, arabinose, fructose, glucuronic acid, and/or pyranosyl sulfate. Examples of suitable polysaccharides include, but are not limited to, guar gums hydroxyethyl guar, hydroxypropyl guar, carboxymethyl guar, carboxymethylhydroxyethyl guar, and carboxymethylhydroxypropyl guar), cellulose derivatives (e.g., hydroxyethyl cellulose, carboxyethylcellulose, carboxymethylcellulose, and carboxymethylhydroxyethylcellulose), xanthan, scleroglucan, succinoglycan, diutan, and the like, and any combination thereof.

Suitable synthetic gelling polymers include, but are not limited to, 2,2′-azobis(2,4-dimethyl valeronitrile), 2,2′-azobis(2,4-dimethyl-4-methoxy valeronitrile), polymers and copolymers of acrylamide ethyltrimethyl ammonium chloride, acrylamide, acrylamide- and methacrylamide-alkyl trialkyl ammonium salts, acrylamidomethylpropane sulfonic acid, acrylamidopropyl trimethyl ammonium chloride, acrylic acid, dimethylaminoethyl methacrylamide, dimethylaminoethyl methacrylate, dimethylaminopropyl methacrylamide, dimethylaminopropylmethacrylamide, dimethyldiallylammonium chloride, dimethylethyl acrylate, fumaramide, methacrylamide, methacrylamidopropyl trimethyl ammonium chloride, methacrylamidopropyldimethyl-n-dodecylammonium chloride, methacrylamidopropyldimethyl-n-octylammonium chloride, methacrylamidopropyltrimethylammonium chloride, methacryloylalkyl trialkyl ammonium salts, methacryloylethyl trimethyl ammonium chloride, methacrylylamidopropyldimethylcetylammonium chloride, N-(3-sulfopropyl)-N-methacrylamidopropyl-N,N-dimethyl ammonium betaine, N,N-dimethylacrylamide, N-methylacrylamide, nonylphenoxypoly(ethyleneoxy)ethylmethacrylate, partially hydrolyzed polyacrylamide, poly 2-amino-2-methyl propane sulfonic acid, polyvinyl alcohol, sodium 2-acrylamido-2-methylpropane sulfonate, quaternized dimethylaminoethylacrylate, quaternized dimethylaminoethylmethacrylate, and the like, and any combination thereof. As examples, the gelling agent may comprise an acrylamide/2-(methacryloyloxy)ethyltrimethylammonium methyl sulfate copolymer, an acrylamide/2-(methacryloyloxy)ethyltrimethylammonium chloride copolymer, a derivatized cellulose that comprises cellulose grafted with an allyl or a vinyl monomer, and the like, and any combination thereof.

Additionally, polymers and copolymers that comprise one or more functional groups (e.g., hydroxyl, cis-hydroxyl, carboxylic acids, derivatives of carboxylic acids, sulfate, sulfonate, phosphate, phosphonate, amino, or amide groups) may be used as gelling polymers.

The gelling polymer described herein is present in a portion or all (i.e., total volume) of the treatment fluids described herein to form a complete treatment fluid (i.e., a final treatment fluid formulation for introduction into a subterranean formation, which would be a joined split initial treatment fluid or a full treatment fluid that was never split as described herein) having a desired viscosity, such as to enable suspension of particulates therein. The amount of gelling polymer accordingly will vary depending on the particular type of subterranean formation operation, the type of gelling polymer selected, the aqueous base fluid used in the treatment fluid, and the like, and any combination thereof. Generally, the gelling polymer is included in the all or portion of the treatment fluid to form a complete treatment fluid, in which the gelling polymer is in the complete treatment fluid in an amount of about 10 pounds per 1000 gallons (lb/Mgal) to about 100 lb/Mgal of the aqueous base fluid in the complete treatment fluid, encompassing any value and subset therebetween. For example, the gelling polymer may be in the complete treatment fluid in an amount of about 10 lb/Mgal to about 25 lb/Mgal, or about 25 lb/Mgal to about 50 lb/Mgal, or about 50 lb/Mgal to about 75 lb/Mgal, or about 75 lb/Mgal to about 100 lb/Mgal, or about 20 lb/Mgal to about 90 lb/Mgal, or about 30 lb/Mgal to about 80 lb/Mgal, or about 40 b/Mgal to about 70 lb/Mgal, or about 50 lb/Mgal to about 60 lb/Mgal of the aqueous base fluid, encompassing any value and subset therebetween. Accordingly, the concentration of the gelling polymer may be greater in a portion of a treatment fluid for hydrating the gelling polymer with an exothermic reactant prior to joining the portion and the remainder of the treatment fluid to form the complete treatment fluid.

The treatment fluids described herein may further include an additive, introduced either before or after the exothermic reactant, or before or after the gelling polymer, or before or after the combination of the exothermic reactant and the gelling polymer in any order, as described below, without departing from the scope of the present disclosure. The selected additive and timing in including the additive must not interfere adversely with the ability of the exothermic reactant to heat a portion or all of the treatment fluid to hydrate the desired amount of gelling polymer. Such additives include, but are not limited to, a salt, a weighting agent, an inert solid, a fluid loss control agent, an emulsifier, a dispersion aid, a corrosion inhibitor, an emulsion thinner, an emulsion thickener, a surfactant, a particulate, a proppant, a gravel particulate, a lost circulation material, a foaming agent, a gas, a pH control additive, a breaker, a biocide, a crosslinker, a stabilizer, a chelating agent, a scale inhibitor, a gas hydrate inhibitor, a mutual solvent, an oxidizer, a reducer, a friction reducer, a clay stabilizing agent, a defoaming agent, and any combination thereof. Typically, where a breaker or a crosslinker is added to the treatment fluid, it is generally added after the polymer is hydrated, but their inclusion prior to hydration (or full hydration) may be suitable in some instances, such as if their action is delayed (e.g., by encapsulation).

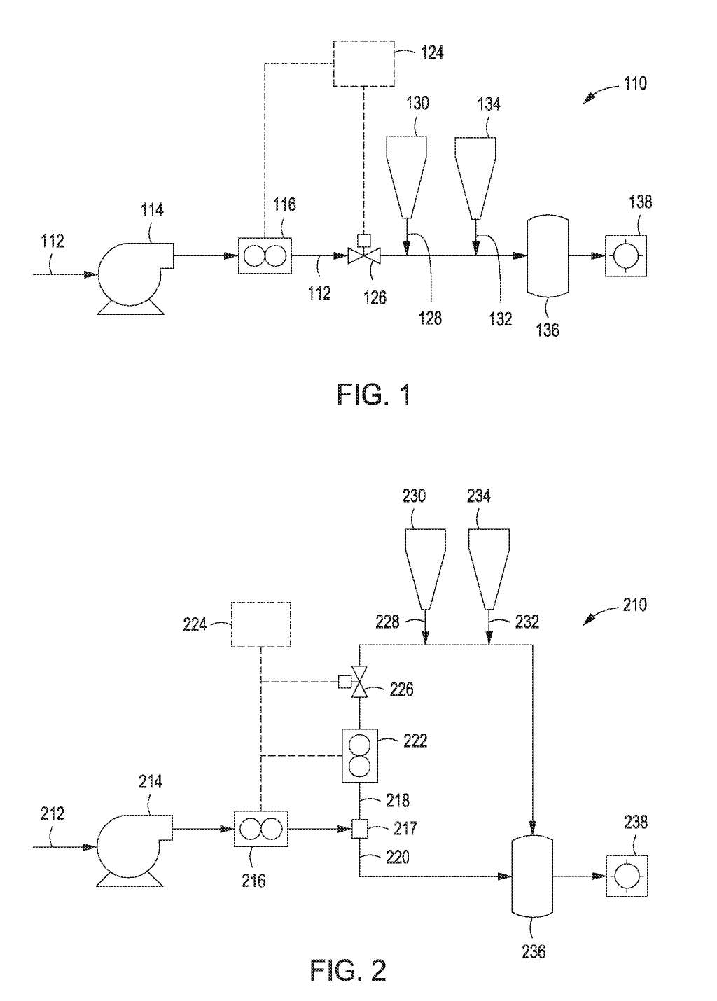

Referring now to FIG. 1, illustrated is a schematic illustration of hydrating a gelling polymer in a complete treatment fluid using an exothermic reactant. As shown, hydration system 110 is illustrated, wherein a fluid flow path 112 allows introduction of a treatment fluid into the hydration system 110 through an inlet by pump 114. The treatment fluid is introduced into the fluid flow path 112 of hydration system 110 at a first temperature, which will typically be ambient temperature, although the first temperature can be higher or lower than ambient temperature, without departing from the scope of the present disclosure. Generally, for the most efficient use of the hydration system 110, the first temperature will be lower than the temperature at which efficient hydration of the gelling polymer can be carried out. That is, the first temperature of the treatment fluid is less than the temperature achieved upon introduction of the exothermic reactant later in the hydration system 110. In most instances, this will be a temperature below about 100° F. (equivalent to about 38° C.), and more typically the first temperature will be below about 75° F. (equivalent to about 24° C.), or below about 50° F. (equivalent to about 10° C.), or below about 40° F. (equivalent to about 4° C.), encompassing any value and subset therebetween. Generally, the first temperature has a lower limit of about 0° F. (equivalent to about −18° C.).

As the treatment fluid enters the hydration system 110 and into the fluid flow path 112, an optional flowmeter 116 can be included in-line with the fluid flow path 112 to measure the total flow of the treatment fluid into the system 110. An optional valve 126 can be used to adjust the flow of the treatment fluid in the fluid flow path 112. An optional control module 124 can be used to adjust the valve 126 based on measurements from the flowmeter 116. Exothermic reactant is introduced into the fluid flow path 112 via inlet 128, which may be fluidically coupled to storage tank 130 for maintaining the exothermic reactant prior to its introduction into the fluid flow path 112, thereby heating the treatment fluid therein. Thereafter, gelling polymer is introduced into the fluid flow path 112 via inlet 132, which may be fluidically coupled to storage tank 134 for maintaining the gelling polymer prior to its introduction into the fluid flow path 112. Alternatively, it is to be appreciated that, in some embodiments, the exothermic reactant may be in storage tank 134 and the gelling polymer may be in storage tank 130, such that the exothermic reactant is introduced into the fluid flow path 112 after the gelling agent is introduced into the fluid flow path 112, without departing from the scope of the present disclosure. Accordingly, the gelling polymer is introduced into the fluid flow path 112 before the temperature of the treatment fluid is elevated with the exothermic reactant, which may allow wetting of the polymer before hydration, thereby reducing potentially formed un-hydrated gelling polymer balls. An optional hydrating vessel 136 may be in-line with fluid flow path 112 to allow the gelling polymer to sufficiently hydrate before introducing the treatment fluid comprising the hydrated gelling polymer into a subterranean formation 138. It will be appreciated, that the gelling polymer may be hydrated directly in the fluid flow path 112 (e.g., when the exothermic reactant elevates the treatment fluid temperature particularly high allowing very rapid hydration of the gelling polymer), without use of the hydrating vessel 136, without departing from the scope of the present disclosure.

Referring now to FIG. 2, with continued reference to FIG. 1, illustrated is a schematic illustration of hydrating a gelling polymer in a portion of a treatment fluid using an exothermic reactant. As shown, hydration system 210 is illustrated, wherein an initial fluid flow path 212 allows introduction of a treatment fluid into the hydration system 210 through an inlet by pump 214. The treatment fluid is introduced into the initial fluid flow path 212 of hydration system 210 at a first temperature, as explained with reference to FIG. 1.

As the treatment fluid enters the hydration system 210 and into the initial fluid flow path 212, an optional flowmeter 216 can be included in-line with the initial fluid flow path 212 to measure the total flow of the treatment fluid into the system 210. Thereafter, the initial fluid flow path 212, and thus the treatment fluid, is split into a first fluid flow path 218 and a second fluid flow path 220 by splitter 217. A second optional flowmeter 222 can be included in-line with the first fluid flow path 218 to measure the total flow of the treatment fluid in the first fluid flow path 218.

For efficient use of hydration system 210, it is typically only necessary for a minor portion of the total treatment fluid from initial fluid flow path 212 to be separated off into the first fluid flow path 218. An optional control module 224 can be used to adjust an optional valve 226 based on the measurements from first flowmeter 216 and second flowmeter 222. From the measurements, control module 224 can calculate the percentage of total treatment fluid from the initial fluid flow path 212 which is split off into the first fluid flow path 218 and, if the percentage does not equal a predetermined value, the control module 224 can adjust valve 226 in order to change the percentage. Generally, treatment fluid split into the first fluid flow path 218 is in the range of about 1% to about 40% of the complete treatment fluid introduced into the hydration system 210 by volume, encompassing any value and subset therebetween. For example, the treatment fluid split into the first fluid flow path 218 may be about 1% to about 5%, or about 1% to about 10°/o, or about 1% to about 20%, or about 1% to about 30%, or about 1% to about 40%, or about 30% to about 40%, or about 20% to about 40%, or about 10% to about 40%, or about 5% to about 35%, or about 10% to about 30%, or about 15% to about 25% of the complete treatment fluid introduced into the hydration system 210 by volume, encompassing any value and subset therebetween. Accordingly, the second fluid flow path 220 comprises the remainder of the complete treatment fluid that is not contained in the first fluid flow path 218 after the complete treatment fluid is split using splitter 217.

Exothermic reactant is introduced into the first fluid flow path 218 via inlet 228, which may be fluidically coupled to storage tank 230 for maintaining the exothermic reactant prior to its introduction into the first fluid flow path 218, thereby heating the portion of the treatment fluid therein. Thereafter, gelling polymer is introduced into the first fluid flow path 212 via inlet 232, which may be fluidically coupled to storage tank 234 for maintaining the gelling polymer prior to its introduction into the first fluid flow path 218. In alternative embodiments, the storage tank 230 may include the gelling polymer and the storage tank 234 may include the exothermic reactant, such that the gelling polymer is introduced into the first fluid path 218 prior to introduction of the exothermic reactant, without departing from the scope of the present disclosure. The first fluid flow path 218 and the second fluid flow path 220 can thereafter be joined, such as by joining the portions of the split treatment fluid into an optional hydrating vessel 236 to allow the gelling polymer to sufficiently hydrate before introducing the now-complete treatment fluid comprising the hydrated gelling polymer into a subterranean formation 238. It will be appreciated, that the gelling polymer may be hydrated directly in the first fluid flow path 218 (e.g., when the exothermic reactant elevates the treatment fluid temperature particularly high allowing very rapid hydration of the gelling polymer), and the first fluid flow path 218 and the second fluid flow path 220 may be joined without use of the hydrating vessel 236, without departing from the scope of the present disclosure.

In alternative examples, rather than splitting the treatment fluid after introducing the treatment fluid through a single pump followed by a splitter, the treatment fluid may be pre-split and two separate pumps used to introduce each portion of the treatment fluid into the first fluid flow path and the second fluid flow path directly. Thereafter, the two fluid flow paths are joined, such as described above with reference to FIG. 2.

The exothermic reactant may be added to all or a portion of a treatment fluid prior to introducing the gelling polymer thereto. This ensures that the all or portion of the treatment fluid is heated due to the reaction between the exothermic reactant and the gelling polymer to facilitate and expedite hydration of the gelling polymer. Alternatively, the gelling polymer may be first added to the all or portion of the treatment fluid, provided that the exothermic reactant is thereafter included in the all or portion of the treatment fluid comprising the gelling polymer prior to greater than about 10% of the gelling polymer being hydrated. Accordingly, the gelling polymer may be first introduced into all or a portion of a treatment fluid followed by introduction of the exothermic reactant, provided that no greater than about 10%, about 9%, about 8%, about 7%, about 6%, about 5%, about 4%, about 3%, about 2%, about 1%, or 0% of the gelling polymer hydrates. That is, the exothermic reactant is to be added quickly into the all or portion of the treatment fluid comprising gelling polymer (including prior to any hydration) to benefit from the exothermic reaction and heat of the treatment fluid. Introducing the exothermic reactant before greater than about 10% of the gelling polymer hydrates ensures that the gelling polymer remains sufficiently active to take advantage of the exothermic reaction to decrease further hydration time.

It is further to be appreciated that although not depicted in FIGS. 1 and 2, additional elements of the hydration systems may be included, without departing from the scope of the present disclosure. For example, the hydration systems may further include mixers, heat sources, holding vessels, additive tanks and inlets (e.g., proppant, weighting agents, and the like, as discussed below), blenders, pumps, and other subterranean formation operation surface equipment.

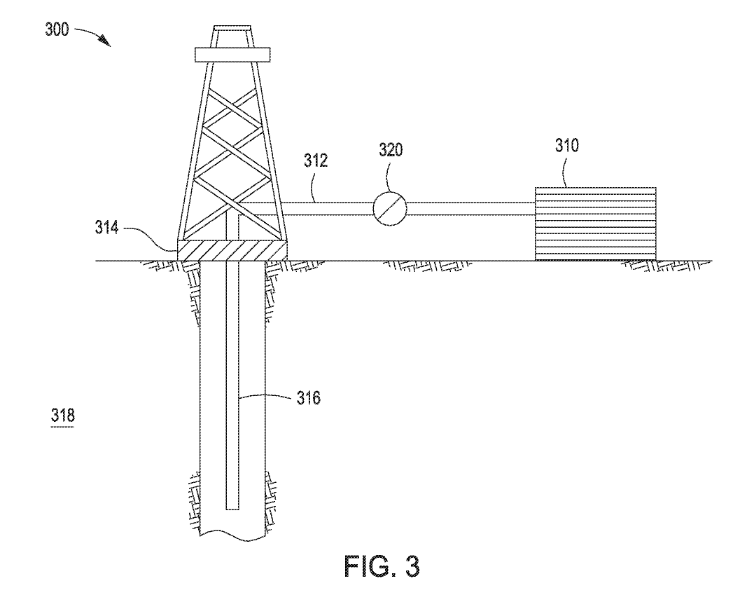

Referring now to FIG. 3, systems configured for delivering the treatment fluids comprising the hydrated gelling polymer described herein to a downhole location are described, such as during a hydraulic fracturing operation. The systems can comprise a pump fluidly coupled to a tubular, the tubular containing a treatment fluid comprising the proppant aggregates, referred to below simply as “treatment fluid.”

The pump may be a high-pressure pump. As used herein, the term “high pressure pump” will refer to a pump that is capable of delivering a fluid downhole at a pressure of about 1000 psi or greater. A high-pressure pump may be used when it is desired to introduce the treatment fluid to a subterranean formation at or above a fracture gradient of the subterranean formation, but it may also be used in cases where fracturing is not desired. The high-pressure pump may be capable of fluidly conveying particulate matter, such as proppant particulates, into the subterranean formation. Suitable high-pressure pumps will be known to one having ordinary skill in the art and may include, but are not limited to, floating piston pumps and positive displacement pumps.

Alternatively, the pump may be a low-pressure pump. As used herein, the term “low pressure pump” will refer to a pump that operates at a pressure of about 1000 psi or less. Alternatively, a low-pressure pump may be fluidly coupled to a high-pressure pump that is fluidly coupled to the tubular. That is, the low-pressure pump may be configured to convey the treatment fluid to the high-pressure pump. Accordingly, the low-pressure pump may “step up” the pressure of the treatment fluid before it reaches the high-pressure pump.

The systems described herein can additionally comprise a mixing tank that is upstream of the pump and in which the treatment fluid is formulated. The pump (e.g., a low-pressure pump, a high-pressure pump, or a combination thereof) may convey the treatment fluid from the mixing tank or other source of the treatment fluid to the tubular. Alternatively, the treatment fluid can be formulated offsite and transported to a worksite, in which case the treatment fluid may be introduced to the tubular via the pump directly from its shipping container (e.g., a truck, a railcar, a barge, or the like) or from a transport pipeline. In any event, the treatment fluid may be drawn into the pump, elevated to an appropriate pressure, and then introduced into the tubular for delivery downhole.

FIG. 3 shows an illustrative schematic of a system that can deliver treatment fluids of the present disclosure to a downhole location. It should be noted that while FIG. 3 generally depicts a land-based system, it is to be recognized that like systems may be operated in subsea locations as well. As depicted in FIG. 3, system 300 may include hydrating vessel 310, which may be substantially similar or the same as hydrating vessel 136 and 236 of FIGS. 1 and 2, respectively. The treatment fluid may be conveyed via line 312 to wellhead 314, where the treatment fluid enters tubular 316, tubular 316 extending from wellhead 314 into subterranean formation 318. Upon being ejected from tubular 316, the treatment fluid may subsequently penetrate into subterranean formation 318. In some instances, tubular 316 may have a plurality of orifices (not shown) through which the treatment fluid of the present disclosure may enter the wellbore proximal to a portion of the subterranean formation 318 to be treated. In some instances, the wellbore may further comprise equipment or tools (not shown) for zonal isolation of a portion of the subterranean formation 318 to be treated.

Pump 320 may be configured to raise the pressure of the treatment fluid to a desired degree before its introduction into tubular 316. It is to be recognized that system 300 is merely exemplary in nature and various additional components may be present that have not necessarily been depicted in FIG. 3 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like, any of which may additionally be included in the hydration systems of FIGS. 1 and 2.

Although not depicted in FIG. 3, the treatment fluid may flow back to wellhead 314 and exit subterranean formation 318. In some instances, the treatment fluid that has flowed back to wellhead 314 may subsequently be recovered and recirculated to subterranean formation 318. Alternatively, the treatment fluid may be recovered and used in a different subterranean formation, a different operation, or a different industrial application.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 3.

Examples disclosed herein include:

### Example A

A method comprising: providing a fluid flow path, the fluid flow path allowing passage of a treatment fluid therethrough, wherein the treatment fluid comprises an aqueous base fluid; introducing an exothermic reactant into the fluid flow path; reacting the exothermic reactant with the aqueous base fluid, thereby heating the treatment fluid; introducing a gelling polymer into the fluid flow path; hydrating the gelling polymer in the treatment fluid; and introducing the treatment fluid into a subterranean formation.

Example A may have one or more of the following additional elements in any combination:

Element A1: Wherein the exothermic reactant is an anhydrous compound.

Element A2: Wherein the exothermic reactant is anhydrous ammonia.

Element A3: Wherein the exothermic reactant is anhydrous ammonia and is included in the treatment fluid in an amount of less than about 10% by weight of the aqueous base fluid.

Element A4: Wherein reacting the exothermic reactant heats the treatment fluid at least about 35° F. hotter than prior to reacting the exothermic reactant.

Element A5: Wherein the exothermic reactant is introduced into the fluid flow path prior to introducing the gelling polymer into the fluid flow path.

Element A6: Wherein the exothermic reactant is introduced into the fluid flow path after introducing the gelling polymer into the fluid flow path, and before greater than about 10% of the gelling polymer hydrates.

Element A7: Further comprising a tubular extending from a wellhead and into the subterranean formation forming an annulus between the tubular and the subterranean formation, and a pump fluidly coupled to the tubular, the tubular or the annulus containing the treatment fluid.

By way of non-limiting example, exemplary combinations applicable to A include: A1-A4 and A6-A7; A1-A4, A5, and A7; A1, A4 and A7; A2 and A5; A3, A6, and A7; A1, A2, and A3; A4 and A4; A2 and AG; and the like.

### Example B

A method comprising: providing a first fluid flow path, the first fluid flow path allowing passage of a treatment fluid therethrough, wherein the treatment fluid comprises an aqueous base fluid; providing a second fluid flow path, the second fluid flow path allowing passage of a portion of the treatment fluid therethrough; introducing an exothermic reactant into the second fluid flow path; reacting the exothermic reactant with the aqueous base fluid in the portion of the treatment fluid in the second fluid flow path, thereby heating the portion of the treatment fluid; introducing a gelling polymer into the portion of the treatment fluid in the second fluid flow path; hydrating the gelling polymer in the portion of the treatment fluid; joining the first fluid flow path and the second fluid flow path, thereby forming a complete treatment fluid; and introducing the complete treatment fluid into a subterranean formation.

Example B may have one or more of the following additional elements in any combination:

Element B1: Wherein the exothermic reactant is an anhydrous compound.

Element B2: Wherein the exothermic reactant is anhydrous ammonia.

Element B3: Wherein the exothermic reactant is anhydrous ammonia and is included in the portion of the treatment fluid in the second fluid flow path in an amount of less than about 10% by weight of the aqueous base fluid.

Element B4: Wherein reacting the exothermic reactant heats the portion of the treatment fluid in the second flow path at least about 35° F. hotter than prior to reacting the exothermic reactant.

Element B5: Wherein the exothermic reactant is introduced into the second fluid flow path prior to introducing the gelling polymer into the second fluid flow path.

Element B6: Wherein the exothermic reactant is introduced into the second fluid flow path after introducing the gelling polymer into the second fluid flow path, and before greater than about 10% of the gelling polymer hydrates.

Element B7: Further comprising a tubular extending from a wellhead and into the subterranean formation forming an annulus between the tubular and the subterranean formation, and a pump fluidly coupled to the tubular, the tubular or the annulus containing the complete treatment fluid.

By way of non-limiting example, exemplary combinations applicable to B include: B1-B4 and B6-B7; B1-B4, B5, and B7; B2, B3, and B5; B6 and B7; B1 and B7; B1, B2, and B6; B3, B4, and B5; B1 and B6; and the like.

### Example C

A system comprising: a fluid flow path, the fluid flow path allowing passage of a treatment fluid therethrough, wherein the treatment fluid comprises an aqueous base fluid; a first inlet for introducing an exothermic reactant into the fluid flow path, wherein the exothermic reactant reacts with the aqueous base fluid, thereby heating the treatment fluid; a second inlet for introducing a gelling polymer into the fluid flow path, wherein the gelling polymer is hydrated in the treatment fluid; and a tubular extending from the fluid flow path and into a subterranean formation, and a pump fluidly coupled to the tubular for placement of the treatment fluid into the subterranean formation.

Example C may have one or more of the following additional elements in any combination:

Element C1: Wherein the exothermic reactant is an anhydrous compound.

Element C2: Wherein the exothermic reactant is anhydrous ammonia.

Element C3: Wherein the exothermic reactant is anhydrous ammonia and is included in the treatment fluid in an amount of less than about 10% by weight of the aqueous base fluid.

By way of non-limiting example, exemplary combinations applicable to C include: C1-C3; C1 and C2; C1 and C3; C2 and C3; and the like.

To facilitate a better understanding of the embodiments of the present disclosure, the following examples are given. In no way should the following examples be read to limit, or to define, the scope of the disclosure.

### Example 1

In this example, the influence of pH on hydration of a gelling polymer in an aqueous base fluid was examined under different temperatures. The purpose of the example was to determine whether the pH change expected to occur with a reaction between anhydrous ammonia (or other anhydrous compound) and an aqueous base fluid, for example, could be overcome or otherwise lessened due to the heat generated by such a reaction. Three test fluids (TF1, TF2, and TF3) were prepared by using a guar gum dry-polymer gelling polymer in fresh water (i.e., the aqueous base fluid). Each of the test fluids was prepared by hydrating the gelling polymer in 1000 milliliters (ml) of fresh water to achieve a concentration of 30 lb/Mgal of the gelling polymer. Each of TF1, TF2, and TF3 were hydrated at a certain temperature and had a particular pH value, where the elevated pH was achieved by adding a solution of sodium hydroxide pH adjusting agent to the fresh water. TF1 was hydrated at pH 6.85 and 72° F., TF2 was hydrated at pH 10 and 72° F., and TF3 was hydrated at pH 10 and 100° F.

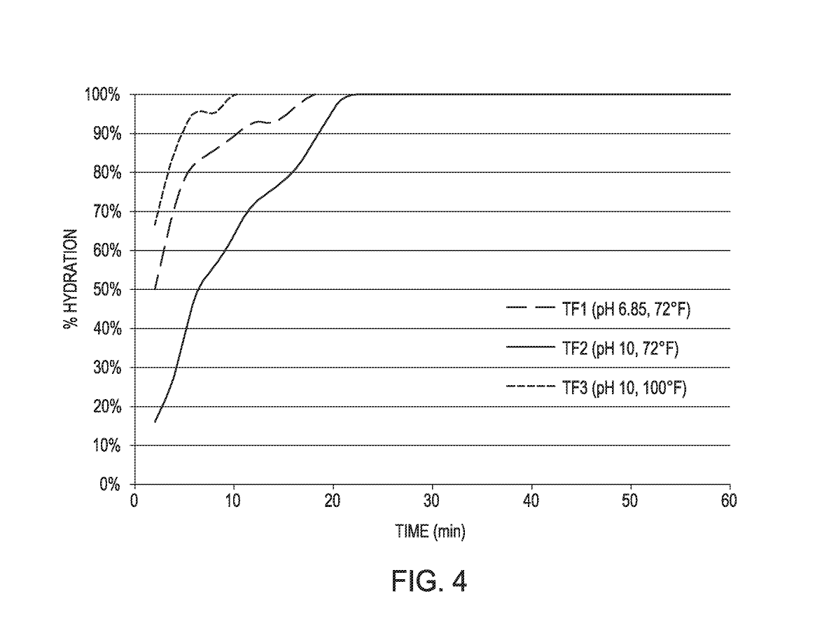

Hydration time was determined using a coquette coaxial cylinder rotational viscometer to measure the viscosity of each treatment fluid. A reading was taken after 1 minute, and subsequent readings were taken every two minutes. The results are provided in FIG. 4.

As shown, the gelling polymer was able to hydrate at both pH 6.85 (TF1) and at the elevated pH of 10 (TF2) at a temperature of 72° F., although the gelling polymer in TF1 hydrated at a much faster rate due to the decreased pH. Raising the temperature to 100° F. at pH 10 (TF3), however, overcame the prolonged hydration time due to the elevated pH. Indeed, the gelling polymer in TF3 even hydrated faster than the gelling polymer in TF1 at the lower pH. Unexpectedly, the gelling polymer quickly hydrated despite the elevated pH when temperature was increased, indicating that temperature has a larger impact on hydration time than pH.

### Example 2

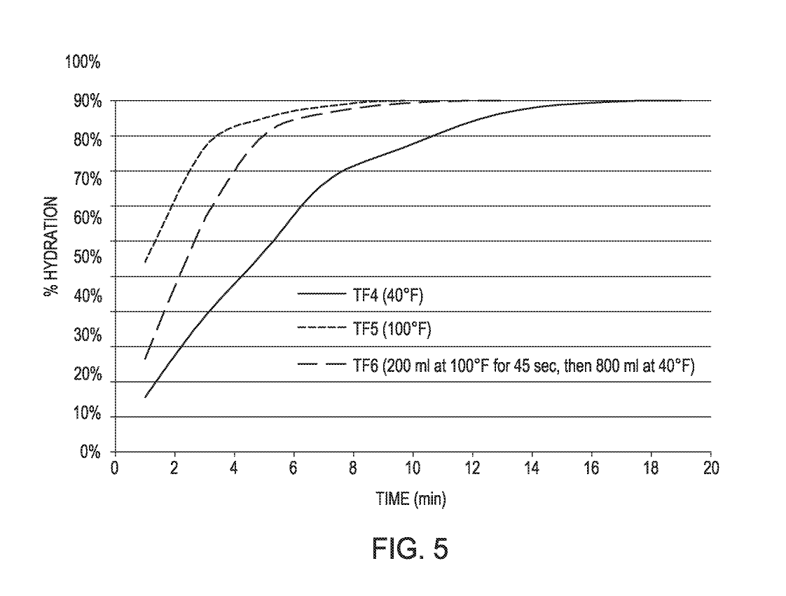

In this example, the ability of an exothermic reactant to be used on a portion or a full treatment fluid volume was evaluated. Three test fluids (TF4, TF5, and TF6) were prepared by using a guar gum dry-polymer gelling polymer in fresh water. For TF4 and TF5, the gelling polymer was hydrated by adding 1000 ml of fresh water to achieve a concentration of 80 lb/Mgal of the gelling polymer. TF4 was hydrated at 40° F. and TF5 was hydrated at 100° F. TF6 was prepared by hydrating the same amount of gelling polymer compared to TF4 and TF5 (to achieve a final complete treatment fluid concentration of 80 lb/Mgal in 1000 ml of fresh water) in only 200 ml at 100° F. for 45 seconds, followed by the addition of 800 ml of fresh water at 40° F. Accordingly, the final concentration of TF5 was 80 lb/Mgal of gelling polymer after the 200 ml and 800 ml were combined. TF5 represents hydrating all of the necessary gelling polymer for a complete treatment fluid in only a portion of the treatment fluid at elevated temperatures, before joining back the split portions of the treatment fluid, as described above. Hydration times were determined as provided in Example 1. The results are provided in FIG. 5.

As shown, TF4 hydrated within 15 minutes (min) at 40° F., TF5 hydrated much faster within 9 min (100° F.), and TF6 hydrated within 11 min (200 ml at 100° F. with the gelling polymer, followed by 800 ml at 40° F.). Accordingly, the hydration time of TF6 was significantly reduced compared to TF4 and approached the performance of TF5, but used only ⅕ of the energy to heat the initial hydration fresh water. Accordingly, as previously explained, a split stream treatment fluid process can reduce hydration times while obtaining better gelling polymer hydration to reduce waste. Moreover, a split stream process uses only a fraction of the energy to heat the treatment fluid to achieve such desirable gelling polymer hydration times.

Therefore, the examples and embodiments disclosed herein are well adapted to attain the ends and advantages mentioned as well as those that are inherent therein. The particular examples and embodiments disclosed above are illustrative only, as they may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present disclosure. The examples and embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method comprising:
providing a fluid flow path, the fluid flow path allowing passage of a treatment fluid therethrough, wherein the treatment fluid comprises an aqueous base fluid;
introducing an exothermic reactant into the fluid flow path;
reacting the exothermic reactant with the aqueous base fluid, thereby heating the treatment fluid;
introducing a gelling polymer into the fluid flow path;
hydrating the gelling polymer in the treatment fluid; and
introducing the treatment fluid into a subterranean formation.

2. The method of claim 1, wherein the exothermic reactant is an anhydrous compound.

3. The method of claim 1, wherein the exothermic reactant is anhydrous ammonia.

4. The method of claim 1, wherein the exothermic reactant is anhydrous ammonia and is included in the treatment fluid in an amount of less than about 10% by weight of the aqueous base fluid.

5. The method of claim 1, wherein reacting the exothermic reactant heats the treatment fluid at least about 35° F. hotter than prior to reacting the exothermic reactant.

6. The method of claim 1, wherein the exothermic reactant is introduced into the fluid flow path prior to introducing the gelling polymer into the fluid flow path.

7. The method of claim 1, wherein the exothermic reactant is introduced into the fluid flow path after introducing the gelling polymer into the fluid flow path, and before greater than about 10% of the gelling polymer hydrates.

8. The method of claim 1, further comprising a tubular extending from a wellhead and into the subterranean formation forming an annulus between the tubular and the subterranean formation, and a pump fluidly coupled to the tubular, the tubular or the annulus containing the treatment fluid.

9. A method comprising:
providing a first fluid flow path, the first fluid flow path allowing passage of a treatment fluid therethrough, wherein the treatment fluid comprises an aqueous base fluid;
providing a second fluid flow path, the second fluid flow path allowing passage of a portion of the treatment fluid therethrough;
introducing an exothermic reactant into the second fluid flow path;
reacting the exothermic reactant with the aqueous base fluid in the portion of the treatment fluid in the second fluid flow path, thereby heating the portion of the treatment fluid;
introducing a gelling polymer into the portion of the treatment fluid in the second fluid flow path;
hydrating the gelling polymer in the portion of the treatment fluid;
joining the first fluid flow path and the second fluid flow path, thereby forming a complete treatment fluid; and
introducing the complete treatment fluid into a subterranean formation.

10. The method of claim 9, wherein the exothermic reactant is an anhydrous compound.

11. The method of claim 9, wherein the exothermic reactant is anhydrous ammonia.

12. The method of claim 9, wherein the exothermic reactant is anhydrous ammonia and is included in the portion of the treatment fluid in the second fluid flow path in an amount of less than about 10% by weight of the aqueous base fluid.

13. The method of claim 9, wherein reacting the exothermic reactant heats the portion of the treatment fluid in the second flow path at least about 35° F. hotter than prior to reacting the exothermic reactant.

14. The method of claim 9, wherein the exothermic reactant is introduced into the second fluid flow path prior to introducing the gelling polymer into the second fluid flow path.

15. The method of claim 9, wherein the exothermic reactant is introduced into the second fluid flow path after introducing the gelling polymer into the second fluid flow path, and before greater than about 10% of the gelling polymer hydrates.

16. The method of claim 9, further comprising a tubular extending from a wellhead and into the subterranean formation forming an annulus between the tubular and the subterranean formation, and a pump fluidly coupled to the tubular, the tubular or the annulus containing the complete treatment fluid.

17. A system comprising:
a fluid flow path, the fluid flow path allowing passage of a treatment fluid therethrough, wherein the treatment fluid comprises an aqueous base fluid;
a first inlet for introducing an exothermic reactant into the fluid flow path, wherein the exothermic reactant reacts with the aqueous base fluid, thereby heating the treatment fluid;
a second inlet for introducing a gelling polymer into the fluid flow path, wherein the gelling polymer is hydrated in the treatment fluid; and
a tubular extending from the fluid flow path and into a subterranean formation, and a pump fluidly coupled to the tubular for placement of the treatment fluid into the subterranean formation.

18. The system of claim 17, wherein the exothermic reactant is an anhydrous compound.

19. The system of claim 17, wherein the exothermic reactant is anhydrous ammonia.

20. The system of claim 17, wherein the exothermic reactant is anhydrous ammonia and is included in the treatment fluid in an amount of less than about 10% by weight of the aqueous base fluid.
